(19) United States
(12) Patent Application Publication
(10) Pub. No.: US 2016/0366856 A1
(43) Pub. Date: Dec. 22, 2016

(54) SYSTEMS AND METHODS FOR RESTRAINING AN ANIMAL

(71) Applicant: Eric LUI, Auburn, WA (US)

(72) Inventor: Eric LUI, Auburn, WA (US)

(21) Appl. No.: 15/187,009

(22) Filed: Jun. 20, 2016

Related U.S. Application Data
(60) Provisional application No. 62/182,263, filed on Jun. 19, 2015.

(51) Int. Cl. A01K 15/04; A61D 3/00

(52) U.S. Cl. CPC A01K 15/04; A61D 3/00

(57) ABSTRACT

A system and device for restraining an animal. A bracket and crossbar provide a means by which the system can be disposed on or over a door or window jamb. The crossbar provides a counter-force to a mount disposed on top of the door or window header, the crossbar having been disposed through the door or window and providing counter-pressure on the frame of the door or window. The system includes a suspension mechanism by which an animal can be suspended from the bracket. The suspension mechanism includes a means for adjusting the length, allowing the animal to be lifted off the ground or floor.

### PRIORITY CLAIM

This application claims the benefit of U.S. provisional patent application No. 62/182,263, filed Jun. 19, 2015 (our ref LUIE-1-1001-1). The foregoing application is incorporated in its entirety as if fully set forth herein.

### BACKGROUND OF THE INVENTION

Routine treatments that a person may perform include brushing teeth, cleaning ears, being groomed, trimming nails, receiving injections, and anything else an animal owner may deem necessary to keep their pets healthy. However, many animals see these treatments as frightening or painful experiences and refuse to have these treatments performed. They will fight the pet owner and make it difficult to perform these task. Therefore, restraint is sometimes necessary in order to provide care for an animal. Even professionals (i.e. animal groomers/veterinarians) often require two or more people to restrain an animal. This invention allows a single user the ability to care for their animal. It also causes the animal to stay in one place and prevents the animal from running away from this necessary care. By providing a way to hold an animal in place, an animal owner can much easily administer these treatments when necessary in the comfort of the animal's own home.

### SUMMARY OF THE INVENTION

This invention relates generally to restraints, and, more specifically, to systems and methods for restraining an animal.

Disclosed is an animal restraint system that suspends an animal in the air, immobilizing it. This allows a person to be able to perform at-home treatments for their animal. The apparatus disclosed herein consists essentially of an L-Shaped bracket device, an animal harness, and two adjustable suspension straps. The device fits into any standard door frame, and may be adjustable to accommodate non-standard widths. An animal is placed into the harness, and then elevated to immobilize and restrain the animal.

The foregoing is a summary and thus contains, by necessity, simplifications, generalizations and omissions of detail; consequently, those skilled in the art will appreciate that the summary is illustrative only and is NOT intended to be in any way limiting. Other aspects, embodiments, features and advantages of the device and/or processes and/or other subject matter described herein will become apparent in the teachings set forth herein.

### BRIEF DESCRIPTION OF THE DRAWINGS

Certain embodiments of the present invention are described in detail below with reference to the following drawings:

FIG. 1 is an isometric view of one embodiment of the animal lift;

FIG. 2 is a detailed isometric view of one embodiment of the animal lift;

FIG. 3 is an exploded isometric view of one embodiment of the animal lift;

FIG. 4a is a front isometric environmental view of one embodiment of the animal lift in use;

FIG. 4b is a front isometric environmental view of one embodiment of the animal lift in use;

FIG. 4c is a rear isometric environmental view of one embodiment of the animal lift in use; and

FIG. 5 is a side cross-sectional view of the one embodiment of the animal lift in use.

### DETAILED DESCRIPTION

This invention relates generally to restraints, and, more specifically, to systems and methods for restraining an animal. Specific details of certain embodiments of the invention are set forth in the following description and the figures to provide a thorough understanding of such embodiments. The present invention may have additional embodiments, may be practiced without one or more of the details described for any particular described embodiment, or may have any detail described for one particular embodiment practiced with any other detail described for another embodiment.

The invention disclosed herein is an animal restraint and lifting system. It consists essentially of a mount, a bracket, and a crossbar.

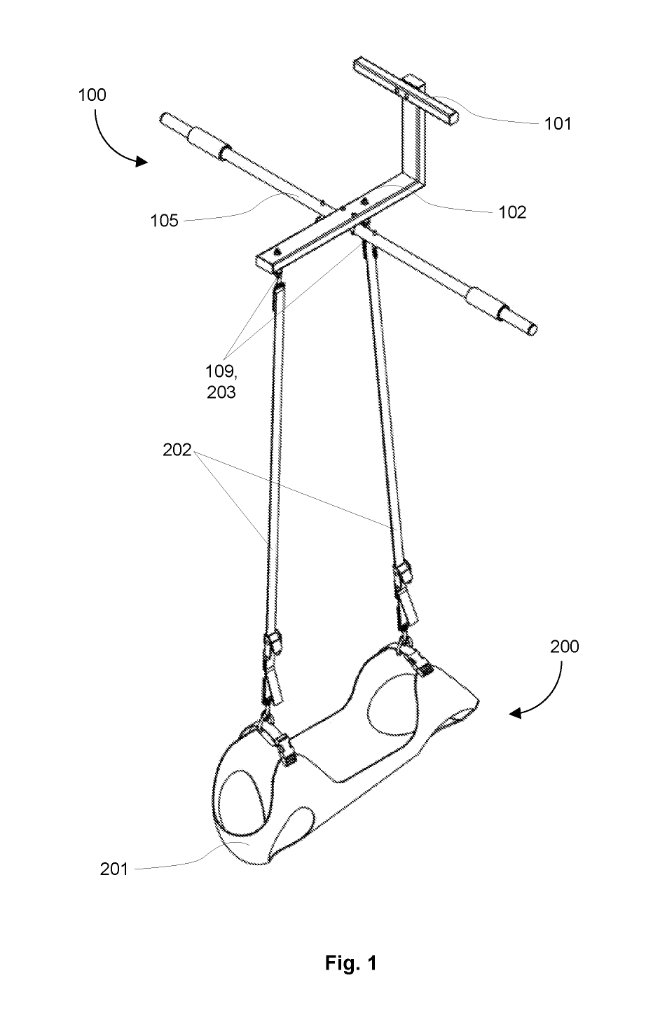

FIG. 1 is an isometric view of one embodiment of the animal lift 100, depicted as it would be prepared for use when coupled with harness system 200. Mount 101 is, in preferred embodiments, a rectangular piece configured to sit atop a standard door frame, header, or casing, using the strength of the structure of the door to support the weight of the device and the animal suspended therein. In some embodiments, the mounting piece may be substantially the same length as the door header; in other embodiments, the mounting piece may be shorter than the header. In some embodiments, the mounting piece may be aluminum to maximize strength while minimizing weight and cost. In other embodiments, the mounting piece may be any rigid material, such as other metals, plastics, wood, etc., depending on the material properties needed for the particular application.

The mount 101 is coupled with bracket 102. In some embodiments, bracket 102 may be metallic, such as steel, or other materials depending on the strength and flexibility requirements of the particular use. For example, an animal lift configured and sized for immobilizing rodents may be constructed of a plastic, whereas animal lifts configured and sized for immobilizing a canine may be constructed of metals. Some embodiments of the animal lift may include a plurality of materials in order to maximize strength and minimize weight. It should be understood that a primary material property concern is rigidity and strength, such that the lift does not distort under the weight of an animal, even if the animal is wiggling or squirming. Mount 101 may be coupled with bracket 102 by many methods, including but not limited to fasteners (as depicted in FIG. 1), weld, adhesive, or by virtue of having been machined from a single piece of material. In some embodiments, bracket 102 may include a mounting sheet to which mount 101 is coupled. In other embodiments, mount 101 may be coupled directly with the vertical leg of bracket 102.

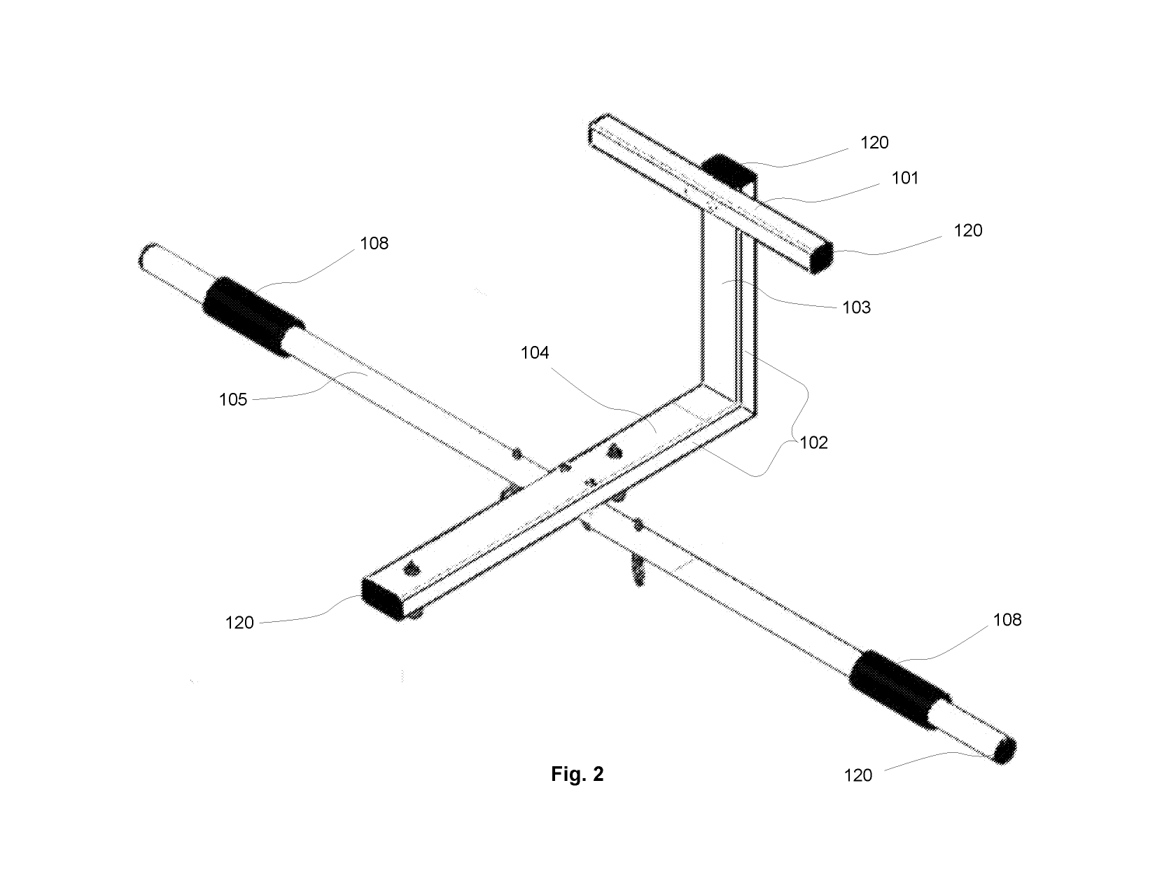

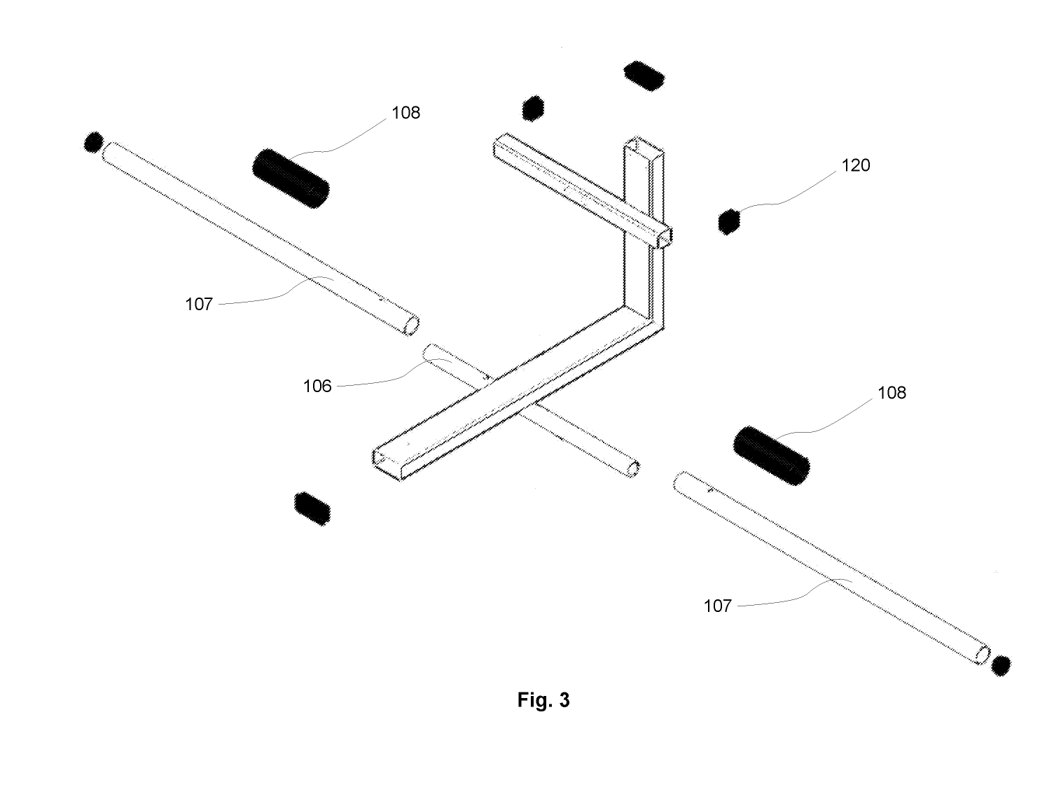

Bracket 102 is substantially L-shaped, comprising a first vertical member and a second horizontal member. This is discussed in more detail in FIG. 2. In preferred embodiments, bracket 102 is coupled with crossbar 105. Crossbar 105 is typically longer than mount 101, configured to reach across a standard door frame. As such, particular embodiments may include a crossbar 105 that is a fixed length, such as 33 or 35 inches in the United States, which allows some overlap onto the frame of a standard 32 inch door. However, some embodiments may include a crossbar 105 that is telescoping, allowing it to reach varying widths and therefore accommodate doors of different widths, including wide doors in homes with handicap access, or narrow doors such as closet doors. In telescoping embodiments, crossbar 105 may be comprised of a fixed bar 106 and one or more movable bars 107 (see FIG. 3). Crossbar 105 may also include one or more locking means, such as a cotter pin, a hitch pin, a flip lock, a twist lock, a push-button lock, etc., and one or more holes configured to receive the locking means, such that the crossbar may be fixed at a particular desired length. One purpose the crossbar 105 is to provide counter pressure on the door frame to hold the apparatus in place, so any length of bar that spans the user's door width should meet this requirement. In some embodiments, the bar may be hollow, while in other embodiments, the bar may be solid. In some embodiments, the bar may be round. In other embodiments, the bar may be rectangular, square, triangular, or any other shape that permits the telescoping function of the bar.

In order to restrain the animal, the animal lift 100 must be coupled with a restraining means 200. In preferred embodiments, restraining means 200 includes a harness 201 configured to securely wrap the underside of an animal while allowing access to the animals legs and feet. In some embodiments, harness 201 is suspended from the lift 100 via one or more straps, 202. Straps 202 may be removably coupleable with lift 100 via one or more hooks 109 and one or more buckles 203. In preferred embodiments, the coupling means are disposed on the horizontal member of bracket 102. In some embodiments, such as the fixed-width embodiments of crossbar 105, the coupling means may be disposed on the crossbar instead of the horizontal member of bracket 102. The particular means of coupling strap 202 with lift 100 may vary, but a hook-and-eyelet bolt system, a carabiner, a pulley-and-rope system, etc., would all be sufficient. In some embodiments, the animal is raised toward the lift 100 by virtue of pulling the strap 202 through the hook 109, such as when hook 109 is in fact a pulley system. This type of system would likely require a locking means for the rope, such as a tending pulley or a hitch climber. In other embodiments, straps 202 may be comprised of something like ratchet straps, which include a buckle through which excess strap length can be pulled, shortening the length of the strap and raising the animal. In some embodiments, one or more hooks may be disposed substantially in the middle of horizontal member 104 (see FIG. 3), and in other embodiments, the hooks may be disposed such that one hook is in front of crossbar 105 and one is behind, as viewed from the front environmental view depicted in FIG. 1. The precise location of hooks 109 may depend on the particular application for which the particular embodiment is contemplated, but it should be understood that the hooks are disposed along the horizontal portion of bracket 102, such that the animal is slightly in front of the door.

FIG. 2 is a close-up, detailed isometric view of one embodiment of the animal lift. Here it can be seen that L-bracket 102 is comprised of a vertical member 103 and a horizontal member 104, and that crossbar 105 is, in preferred embodiments, coupled with horizontal member 104. In some embodiments, vertical member 103 and horizontal member 104 may be permanently or removably coupled, such as via weld, by virtue of having been machined from a single piece of material, or by permanent or removable fasteners. While removably coupling vertical member 103 and horizontal member 104 may lend to better storage options for the user, by virtue of the user being able to break the lift into smaller constituent parts, it may be the case that the strength of the lift is better preserved by a permanent coupling. Therefore, as before, the particular means by which vertical member 103 is coupled with horizontal member 104 may depend on the particular application for which the lift 100 is contemplated.

In fixed length embodiments of crossbar 105, the crossbar may be permanently or removably coupled with horizontal member 104 via fasteners, weld, adhesive, or by virtue of being machined from a single piece of material. FIG. 3 is a depiction of a telescoping embodiment of crossbar 105, in which it may be that only the fixed portion 106 of the crossbar is coupled with the horizontal member 104, while movable members 107 are affixed only to the fixed member 106, allowing a user to adjust the length of the crossbar to fit their particular needs. Returning now to FIG. 2, it can be seen that, in some embodiments, crossbar 105 further includes one or more padded areas 108. Since the lift 100 uses crossbar 105 to provide counter pressure against a door frame, some users may prefer that a padded area 108 be included to minimize damage to the frame paint or material under the paint. As such, padded area 108 may be comprised of a substantially soft or flexible material, such as a soft plastic, a foam, or a rubber material, and it may be comprised of a material designed not to transfer to other surfaces, such as a clear gel or a non-marring rubber.

In order to provide maximum strength with minimum weight, any one element of the lift 100, or all elements thereof, may be hollow. In order to prevent infestation of rodents or insects, the lift 100 may include one or more endcaps 120 at each end of a hollow segment of the lift. While the endcaps 120 may be present at varying locations depending on each embodiment, only exemplary endcaps are included in FIG. 2, and the actual number and location of the endcaps will depend on the particular embodiment of the lift in question.

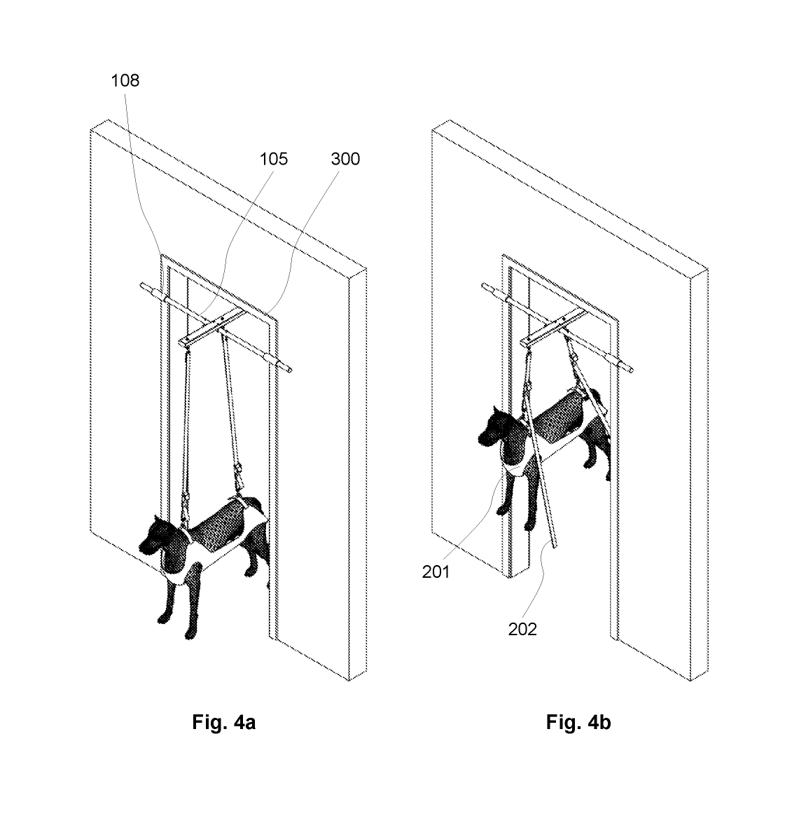

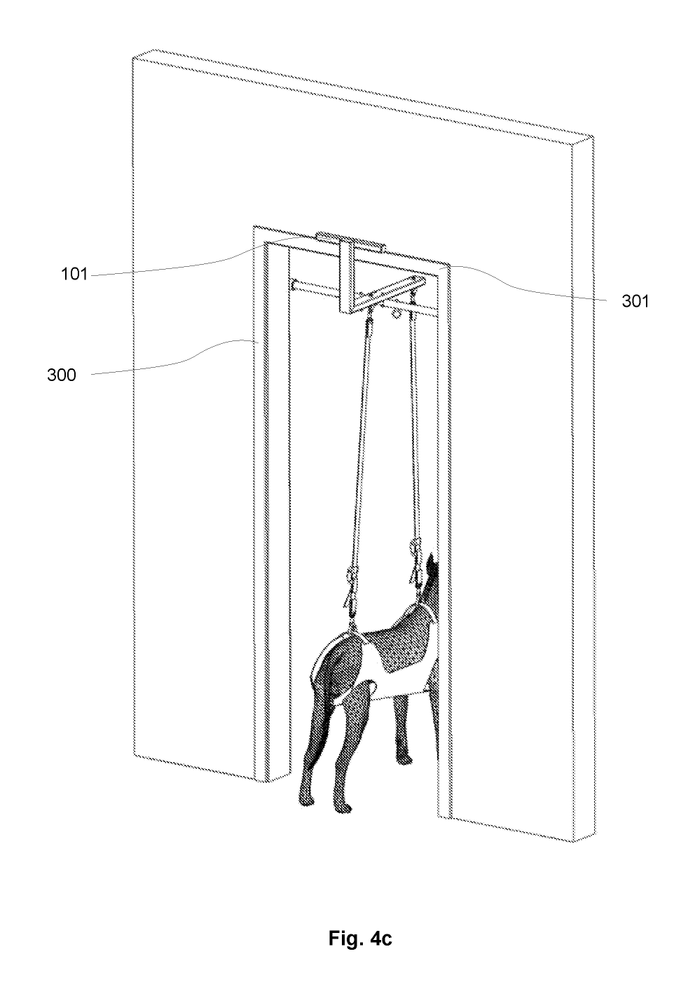

FIG. 4 is composed of three images, FIG. 4a, which is a front environmental isometric showing the lift 100 and harness system 200 in use while the animal is on the ground; FIG. 4b which is a front environmental isometric showing the lift and harness system in use while the animal is suspended; and FIG. 4c, which is a rear environmental isometric showing the lift and harness system in use while the animal is on the ground. In FIG. 4a it can be seen that the animal, while restrained, can still stand on its own. This type of configuration might be useful for preventing an animal from moving while its fur is being groomed or while it learns particular commands, such as “stay”. In particular, FIG. 4a shows that crossbar 105 is configured to span the entire width of door frame 300, allowing padded area 108 to rest on the jamb to prevent marking.

FIG. 4b shows the animal suspended, resting its weight in harness 201, which has been elevated by virtue of the loops formed by straps 202 having been shortened. This type of configuration might be useful for allowing a user to access an animals feet, such that the user can clip nails or claws while preventing the animal from fleeing.

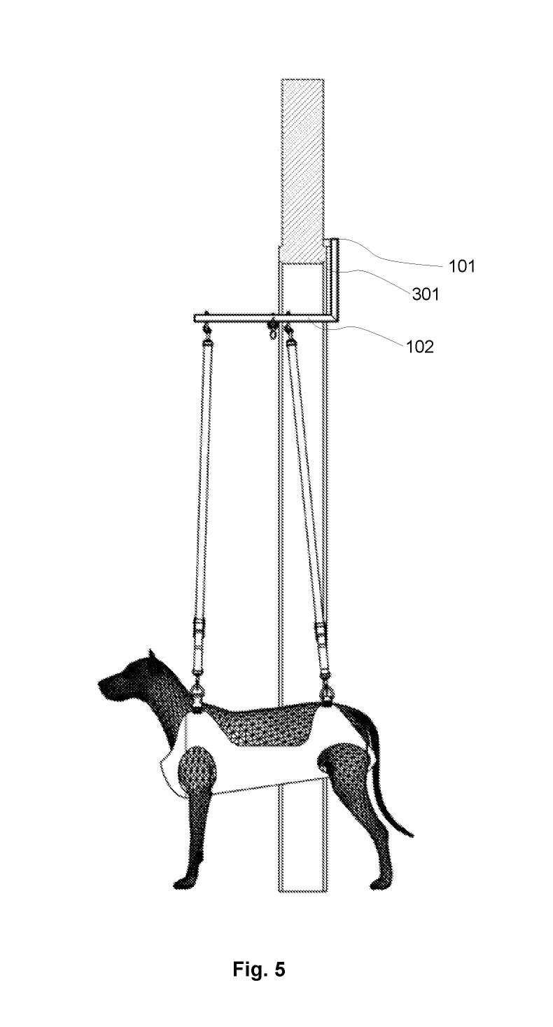

FIG. 4c shows the lift 100 as it is suspended from door frame 300 by virtue of mount 101 resting atop the door header 301. When crossbar 105 is resting against door jamb 300, as in FIG. 4a, and the mount 101 sits atop the door header 301 as in FIG. 4c, the lift 100 is removably fixed in place, such that a squirming animal will be unable to dislodge it. Moreover, the rigid construction of the jamb allows the lift 100 and the jamb 300 to support the weight of most domestic animals, allowing a user greater versatility in the use of the lift. FIG. 5 is a cross-sectional side view of the same configuration as depicted in FIG. 4c, showing that mount 101 rests on header 301, suspending and supporting the remainder of bracket 102.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

While preferred and alternative embodiments of the invention have been illustrated and described, as noted above, many changes can be made without departing from the spirit and scope of the invention. Accordingly, the scope of the invention is not limited by the disclosure of these preferred and alternate embodiments.

What is claimed is:

1. A system for immobilizing an animal, the system comprising:
a mount;
an l-shaped bracket with a vertical member and a horizontal member, wherein the mount is disposed at a first end of the vertical member, and the horizontal member is disposed at a second end of the vertical member;
at least one crossbar coupled with the horizontal member of the l-shaped bracket; and
at least one suspension mechanism coupled with at least one of the crossbar or the horizontal member of the bracket.

2. The system of claim 1, wherein the at least one crossbar coupled with the horizontal member of the l-shaped bracket further comprises:
at least one telescoping bar configured to be changeably fixed at particular widths.

3. The system of claim 2, wherein the at least one telescoping bar further comprises:
a fixed-length bar coupled with the horizontal member of the l-shaped bracket; and
at least one moveable bar coupled with the fixed-length bar, such that moving the movable bar lengthens or shortens a total length of the telescoping bar.

4. The system of claim 2, wherein the at least one telescoping bar further comprises:
at least one locking mechanism such that a total length of the crossbar may be removably fixed at a particular length.

5. The system of claim 1, wherein the at least one crossbar coupled with the horizontal member of the l-shaped bracket further comprises:
a fixed-length crossbar.

6. The system of claim 1, wherein the mount is substantially rectangular in cross-section.

7. The system of claim 1, wherein the at least one suspension mechanism coupled with at least one of the crossbar or the horizontal member of the bracket comprises:
at least one adjustable-length strap with a top end and a bottom end, wherein the top end is removably coupled with at least one of the crossbar or the horizontal member of the bracket; and
at least one restraining mechanism coupled with the bottom end of the at least one adjustable-length strap.

8. The system of claim 7, wherein the at least one adjustable-length strap is a rope-and-pulley system, wherein the pulley is permanently coupled with at least one of the crossbar or the horizontal member of the bracket.

9. The system of claim 7, wherein the at least one adjustable-length strap is disposed through at least one hook on the at least one restraining mechanism, and through at least one hook coupled with at least one of the crossbar or the horizontal member of the bracket.

10. A system for immobilizing an animal, the system comprising:
at least one mount;
an l-shaped bracket with a vertical member and a horizontal member, wherein the mount is permanently coupled with a first end of the vertical member, and the horizontal member is permanently coupled with a second end of the vertical member;
at least one crossbar coupled with the horizontal member of the l-shaped bracket; and
at least one suspension mechanism coupled with the horizontal member of the bracket.

11. The system of claim 10, wherein a cross-section of the at least one mount is substantially rectangular in shape.

12. The system of claim 10, wherein the at least one suspension mechanism coupled with the horizontal member of the bracket comprises:
at least one adjustable-length strap coupled with the horizontal member of the bracket; and
at least one animal harness, the at least one animal harness coupled with the at least one adjustable-length strap such that the at least one animal harness can be raised by shortening the length of the adjustable-length strap.

13. The system of claim 10, wherein the at least one crossbar coupled with the horizontal member of the l-shaped bracket comprises:
a middle section coupled with the horizontal member of the l-shaped bracket;
a first end section adjustably coupled with a first end of the middle section; and
a second end section adjustably coupled with a second end of the middle section, such that adjusting at least one of the first end section or the second end section changes the overall length of the at least one crossbar.

14. The system of claim 13, wherein the first end section and the second end section are configured to receive the first end and the second end, respectively, of the middle section.

15. The system of claim 13, wherein the first end section and the second end section are fixable at particular lengths.
